(19) United States
(12) Patent Application Publication
(10) Pub. No.: US 2017/0017683 A1
(43) Pub. Date: Jan. 19, 2017

(54) Systems And Methods For Storing And Interacting With Data From Heterogeneous Data Sources

(71) Applicant: 28msec, Zurich (CH)

(72) Inventors: Ghislain Fourny, Zurich (CH); Matthias Brantner, Heidelberg (DE); Dennis Knochenwefel, Zurich (CH)

(21) Appl. No.: 15/209,669

(22) Filed: Jul. 13, 2016

Related U.S. Application Data
(60) Provisional application No. 62/191,810, filed on Jul. 13, 2015.

(51) Int. Cl. G06F 17/30

(52) U.S. Cl. CPC G06F 17/30424; G06F 17/30336; G06F 17/30339

(57) ABSTRACT

Systems and methods disclosed herein are used to store and interact with data from heterogeneous data sources. In some embodiments, a method of improved querying of data includes: identifying a data value in a first data source of a plurality of heterogeneous data sources. The method further includes: (i) extracting, from the first data source, one or more characteristics associated with the data value, (ii) creating a cell that includes the data value and the extracted one or more characteristics, and (iii) storing, in an unordered collection of cells, the created cell. The method also includes: receiving a query that specifies a set of one or more required characteristics. In accordance with a determination that the created cell includes each required characteristic in the set, the method includes locating the created cell and presenting, on an electronic device's display, a tabular representation that at least includes the data value.

### RELATED APPLICATION

This application claims priority to U.S. Provisional Application Ser. No. 62/191,810, filed Jul. 13, 2015, which is hereby incorporated by reference in its entirety.

### TECHNICAL FIELD

The disclosed embodiments relate generally to modeling and storing data and, in particular, to storing and interacting with data from heterogeneous data sources using a cell store paradigm.

### BACKGROUND

Conventional data storage models and paradigms encounter numerous issues as the volume of data and the dimensionality used to classify data increases. Therefore, conventional data storage models and paradigms are inefficient and are not able to efficiently and effectively scale-up as data volume and dimensionality requirements increase. Additionally, conventional data storage models store data using a predefined and fixed schema that does not allow for on-the-fly reconfigurations and remodeling of data to suit the diverse requirements of many different business users.

### SUMMARY

Without limiting the scope of the appended claims, after considering this disclosure, and particularly after considering the section entitled “Detailed Description” one will understand how the aspects of various embodiments are implemented and used to store and interact with data from heterogeneous data sources. In particular, the embodiments disclosed herein help to ensure that data is modeled in a flexible way (e.g., using a cell store paradigm) that allows for quick and efficient aggregation of data values based on characteristics associated with the data values. In this way, the cell store paradigm scales up seamlessly with the total number of characteristics associated with the data values and also allows users to model data on an as-needed basis (e.g., the user can model the data using a first schema (or taxonomy) and can then later model that same data using a different schema). In some embodiments, a characteristic describes a particular aspect of a data value (e.g., an exemplary characteristic is a concept dimension with an associated value of assets, used to describe a data value of 3,000,000,000, as explained below in reference to FIG. 1). By using the cell store paradigm and allowing users to flexibly create and interact with various schemas applied to the same data values, the embodiments disclosed herein provide users with the ability to make better and more informed business decisions. Moreover, the cell store paradigm allows for the creation of large-scale collections of cells (e.g., unordered collections of cells, as discussed in more detail below) and querying of the large-scale collection of cells using any number of database query languages and/or information retrieval query languages.

Furthermore, the cell store paradigm described herein also provides the following advantages over conventional data storage technologies: (i) allows for storing cubes of high dimensionality (46,000+ dimensions, 100,000,000+ non-empty cells) (Improvement over OLAP); (ii) cell stores are physically equivalent to tables with large numbers of rows and large numbers of columns (improvement over SQL, ROLAP); (iii) supports primary keys on a large number of underlying attributes (Improvement over column stores); and (iv) is backwards compatible with OLAP and the Business Intelligence (BI) tools universe (can emulate OLAP behavior). Moreover, conventional OLAP data warehouses are commonly considered to become slower with hypercube queries containing more than 10 dimensions. Cell stores have been successfully tested with sub-second hypercube query processing on up to 16 dimensions.

(A1) In accordance with some embodiments, a method for storing and interacting with data from heterogeneous data sources is provided. The method includes: identifying a data value in a first data source of a plurality of heterogeneous data sources. The method further includes: (i) extracting, from the first data source, one or more characteristics associated with the data value, (ii) creating a cell that includes the data value and the one or more characteristics (also referred to herein as the “extracted one or more characteristics”) associated with the data value, and (iii) storing, in an unordered collection of cells the cell (also referred to herein as “the created cell”). The method also includes: receiving a query that specifies a set of one or more required characteristics. In accordance with a determination that the created cell includes each required characteristic in the set of one or more required characteristics (alternatively, in accordance with a determination that the data value is associated with a set of characteristics that matches the set of one or more required characteristics), the method includes: locating the created cell within the unordered collection of cells and presenting, on a display of an electronic device (e.g., on a mobile phone, on a laptop, etc.), a tabular representation that at least includes the data value. In some embodiments, the tabular representation also includes the extracted one or more characteristics associated with the data value.

(A2) In some embodiments of the method of A1, the query further specifies a set of optional characteristics and, in accordance with a determination that the created cell does not include the set of optional characteristics, the method includes: temporarily assigning a default value to the cell for each optional characteristic in the set of optional characteristics. In some embodiments, temporarily assigning the default value includes displaying, in the tabular representation, the default value in a row of data that is associated with the data value. For example, if cell 116-2 does not include a region dimension, but the characteristics (i.e., dimension and value pairs used to describe the data value in cell 116-2) match each required characteristic of the set of one or more required characteristics specified by the query, then the data value associated with the cell 116-2 is presented in the tabular representation with the default value (e.g., a default value of “World” for the region dimension, as shown in row 125 of tabular representation 122 in FIG. 1). In some embodiments, the default value is displayed with a visual identifier for default values (e.g., the default value is bracketed, such as “[World],” or it is labeled as a domain).

(A3) In some embodiments of the method of any one of A1 to A2, presenting the tabular representation includes validating the data value by comparing the data value to other related data values. In some embodiments, validating the data value includes visually flagging the data value within the tabular representation in accordance with a determination that the data value is not valid. In this way, erroneous data values are easily flagged for correction. For example, if the data value and a different data value are each described by a number of shared characteristics (e.g., each data value is described by 1) a first shared characteristic with a dimension of concept and an associated value of assets and 2) a second shared characteristic with a dimension of entity and a value of visto) and at least one distinguishing characteristic (e.g., each data value is described by a third characteristic with a dimension of period, but with differing values associated therewith), then the data value and the different data value are considered to be related to one another. In some embodiments, the method also includes: identifying all related data values, establishing or calculating an average value for the related data values, and determining whether the data value is within at least three standard deviations of the average value. In accordance with a determination that the data value is not within at least three standard deviations of the average value, then the method also includes: presenting an indication, to a user of the electronic device, that the data value is potentially invalid (e.g., presenting a user interface object with a message that identifies the data value and explains that the data value is potentially invalid).

(A4) In some embodiments of the method of any one of A1 to A3, the method includes, in accordance with a determination that no cells in the unordered collection of cells include each required characteristic in the set of one or more required characteristics (e.g., the query returns an empty or null set of cells/results), determining a new data value that includes an audit trail that describes how the new data value was determined. In some embodiments, determining the new data value includes identifying other cells in the unordered collection of cells that include all but one of each of the required characteristics in the set of one or more required characteristics. The method additionally includes determining the new data value based on the data values associated with the identified other cells (i.e., the method approximates a value for the new data value based on the data values associated with the identified other cells).

(A4.1) In some embodiments of the method of any one of A3 to A4, rules for validating the data value and/or rules for determining the new data value are derived from information found in one of the data sources. In some embodiments, a respective rule is directly converted from existing machinery such as XBRL calculation networks or formulas. In some other embodiments, rules such as, but not limited to, roll-ups or roll-forwards may be inferred from structures such as XBRL presentation networks and label roles.

(A5) In some embodiments of the method of any one of A1 to A4, the data value is a first data value of a plurality of data values in the first data source. Also, the extracting, the creating, and the storing are performed with respect to each data value within the plurality of data values in the first data source. In this way, the method builds up a large repository of cells (e.g., the unordered collection of cells 118, FIG. 1).

(A6) In some embodiments of the method of any one of A1 to A5, presenting the tabular representation that at least includes the data value includes determining whether a first characteristic of the extracted one or more characteristics is redundantly-named and in accordance with a determination that the first characteristic is redundantly-named, presenting a notification to a user that the first characteristic is redundantly-named (e.g., by modifying a name associated with the first characteristic so that it maps to a default name for the first characteristic). In some embodiments, the determination that the first characteristic is redundantly-named includes a first determination that the first characteristic is associated with the same dimension as one or more other characteristics (distinct from the first characteristic) and a second determination that the same dimension is associated with two or more values. As an example, if the first characteristic includes a concept dimension with an associated value of “Equity,” the first determination reveals that one or more other characteristics (e.g., characteristics describing cells other than the created cell) include the concept dimension, and the second determination reveals that the concept dimension is associated with two or more values (e.g., “Equity” for the first characteristic and “Capital” for the one or more other characteristics), then the first characteristic is termed redundantly-named as compared to the one or more other characteristics. In some embodiments, a mapping is applied to the unordered collection of cells (and the characteristics associated therewith) in order to group related characteristics (e.g., those that are associated with the same dimension but with differing values for that same dimension) and quickly expose redundant terminology (as explained below).

(A7) In some embodiments of the method of any one of A1 to A6, the created cells include information that allows for distinguishing between two kinds of characteristics referred to as key characteristics and non-key characteristics of the created cell. In some embodiments, key characteristics associated with the created cell uniquely identify the created cell (i.e., the dimensions and associated values associated with each of the key characteristics uniquely identify the created cell as compared to all other cells within the unordered collection of cells). In some embodiments, the information that allows for distinguishing between key and non-key characteristics identifies or flags one or more of the extracted one or more characteristics as key characteristics. In some embodiments, the information that allows for distinguishing between key and non-key characteristics includes other suitable means that allow for distinguishing between key and non-key characteristics. As one example of the use of key and non-key characteristics, if a received query (e.g., a hypercube query) specifies a set of one or more required characteristics and the method includes a first determination that that the created cell has the one or more required characteristics, then the method also (or as an alternative to the first determination) includes a second determination that all of the key characteristics associated with the created cell are in the set of the one or more required characteristics. In accordance with a determination that the created cell has key characteristics that are absent from the set of one or more required characteristics, the created cell will not be presented to the user (e.g., in the tabular representation discussed above, at A1).

(A8) In some embodiments of the method of A7, the method further includes determining whether any two cells in an unordered collection of cells are associated with the same key characteristics (referred to herein as a cell collision). In accordance with a determination that two cells share the same key characteristics, the method includes: providing a notification to the user that a cell collision has been identified (e.g., as a dialog that is displayed on top of the tabular representation). In some embodiments, determining whether any two cells share the exact same key characteristics is performed as a background process that continually executes on a server that is responsible for storing the unordered collection of cells (e.g., server 101, FIG. 1). In some embodiments, determining whether any two cells share the exact same key characteristics is performed in conjunction with extracting data from heterogeneous data sources 106 (extracting operation 107, FIG. 1) and creating cells to store the extracted data (e.g., in conjunction with operations 304, 306, and/or 308, FIG. 3). In this way, the method ensures that cell collisions are identified and resolved in an efficient manner and without any impact to the user.

(A9) In some embodiments of the method of any one of A1 to A8, the extracted one or more characteristics include a concept dimension and a concept value, a period dimension and a period value, an entity dimension and an entity value, and, when meaningful, a unit dimension and unit value. In some embodiments, the concept dimension must appear among the extracted one or more characteristics associated with the created cell and (also or alternatively) among the set of one or more required characteristics in the received query, in order for the created cell to satisfy the determination that the created cell includes each required characteristic in the set of one or more required characteristics.

(A10) In some embodiments of the method of any one of A1 to A9, the unordered collection of cells is indexed based on at least one of the extracted one or more characteristics associated with the data value. In some embodiments, the unordered collection of cells is indexed using one or more of: hash indices, tree indices or range indices, compound indices, geospatial indices, intersection indices, and/or universal indices. In this way, the method is able to locate cells more quickly (e.g., the locating step discussed above at A1 is completed more quickly relative to embodiments in which cells are not indexed).

(A11) In some embodiments of the method of any one of A1 to A10, the created cell is represented as a JavaScript Object Notation (“JSON”) object. In some embodiments, the created cell is represented as an XML document, a BSON document, or using any other hierarchical syntax. In some embodiments, the created cell is stored as a row in a column store.

(A12) In some embodiments of the method of any one of A1 to A11, the received query is generated using a single business intelligence tool and the created cell is displayed in the tabular representation by the single business intelligence tool. The method further includes: providing an application programming interface that exposes the unordered collection of cells with standard protocols and languages such as OLAP, OData, XML for Analysis, MDX, SQL. In some embodiments, the single business intelligence tool is specifically created for interacting with unordered collections of cells (in order to leverage built-in flexibility of the cell store paradigm).

(A13) In some embodiments of the method of any one of A1 to A13, the extracted one or more characteristics (i.e., dimension and associated value pairs) associated with the created cell, as well as the data value if applicable, are associated with one or more human-readable labels in one or more languages. The created cell is displayed to the user in a language of his choice.

(A14) In some embodiments of the method of any one of A1 to A13, the possible values of the extracted characteristics (dimension and values) are organized as an unordered collection of report elements, separately from the unordered collection of cells. Report elements may include concepts, abstracts, dimensions, members, hypercubes, and line-items. Each one of these report elements contains associated properties such as data types, period types, monetary balance, and dimensional type.

(A15) In some embodiments of the method of A14, the report elements may be organized as trees or graphs (“networks”) using appropriate data stores such as document stores or triple stores that natively support these data structures.

(A16) In some embodiments of the method of any one of A14 to A15, report elements as well as networks of report elements can be imported from one of the heterogeneous data sources.

(A17) In some embodiments of the method of any one of A14 to A16, the user interacting with the electronic device may create new cells, new report elements, or reorganize networks of report elements. In some embodiments, the user may create new validation rules or new rules that are then used to create new cells.

(A18) In some embodiments of the method of any one of A1 to A17, the cells can be versioned, for example using one of the dimensions as transaction time. In such embodiments, the latest value available for the same set of characteristics among otherwise colliding sets is taken and shown. In such embodiments, all of the values can be displayed jointly, showing the timeline of data associated with a cell entirely or partially.

(A19) In some embodiments of the method of A18, the user interacting with the electronic device may edit the data value of a cell, which creates a new cell with a newer transaction time characteristic.

(A20) In some embodiments of the method of any one of A1 to A19, report elements and networks can be moved to other storage systems, or exported and serialized to syntaxes such as XBRL.

(A21) In some embodiments of the method of any one of A1 to A20, an underlying storage system that is used to store the unordered collection of cells may be optimized for batch processing (such as Hadoop or Spark) rather than real-time queries, and aggregation queries may be run in parallel on large portions of the entire set of cells.

(A22) In another aspect, the tabular display may be interactive, allowing the user to slice and dice the displayed cells on the fly. In some embodiments, the slicing and dicing is performed on a server system. In some embodiments, the slicing and dicing is performed on a client device. In some other embodiments, the slicing and dicing is performed party on the server system and partly on the client device. In some embodiments, key characteristics are displayed as dicers and non-key characteristics are displayed as slicers. In some other embodiments, some non-key characteristics (e.g., a fiscal year and period) may be promoted to dicers while a key characteristic (e.g., built-in period aspect) may be demoted to a slicer to allow comparison across entities.

(A23) In another aspect, an electronic device (e.g., a server) includes one or more processors, memory, and a display. The memory stores one or more programs configured for execution by the one or more processors, the one or more programs including instructions for performing the method of any one of A1 to A23 described above.

(A24) In yet one further aspect, a non-transitory computer-readable storage medium is provided. The non-transitory computer-readable storage medium stores one or more programs configured for execution by one or more processors of an electronic device (e.g., a server), the one or more programs including instructions for performing the method of any one of A1 to A23 described above.

In some embodiments, the cells and the unordered collection of cells described above are distributed over a plurality of non-transitory computer-readable storage media.

Note that the various embodiments described above can be combined with any other embodiments described herein (e.g., with the operations described below with respect to method 300 and FIG. 3). The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 is a block diagram illustrating an implementation of a cell generation and presentation system, in accordance with some embodiments.

FIG. 2 is a block diagram illustrating an implementation of a server for storing cells and locating cells in response to queries, in accordance with some embodiments.

FIG. 3 illustrates a flowchart representation of a method of storing and interacting with data from heterogeneous data sources, in accordance with some embodiments.

FIGS. 4A-4H are schematics of a display used to illustrate a tabular representation displaying data that is returned in response to a hypercube query, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### BRIEF DESCRIPTION OF THE APPENDICES

For a better understanding of the various described embodiments, reference should be made to the drawings mentioned above and to the Detailed Description section below, in conjunction with the following appendices.

Appendix A includes portions of source code related to configuring data structures to implement the cell store paradigm, configuring a MONGODB data source to store cells, and configuring data structures for processing hypercube queries, in accordance with some embodiments of a cell store paradigm, and provides information that supplements the disclosures provided herein. For example, operations 302-312, discussed below in reference to method 300, are supplemented by the source code provided in Appendix A.

Appendix B includes an abstract data model that is used to describe cell stores, in accordance with some embodiments. It gives a mathematical definition for cells, validation, hypercubes and collisions.

Appendix C includes an example of JSON syntax used for a hypercube, in accordance with some embodiments. As shown in the example in Appendix C, concepts are presented in a hierarchy, as well as each dimension domain as a hierarchy of members. When no such hierarchy is present for a dimension, no filtering is done (ALL). When a dimension is absent, the hypercube filters for its default value. In some embodiments, hypercube syntax appear in section infosets. In some embodiments, the example syntax of Appendix C is used both for importing existing hypercubes from a data source, and for expressing hypercube queries on the fly.

Appendix D includes an example of syntax used for a network, in accordance with some embodiments. Appendix D shows how an arborescent syntax such as JSON or XML is appropriate for expressing a tree of concepts such as a presentation tree. In some embodiments, network syntax appears in section infosets.

Appendix E includes an example of syntax used for the metadata associated with a report element, in accordance with some embodiments. In the example shown in Appendix E, the metadata encompasses a set of properties (such as type, period type, etc.) as well as a nested set of labels with various semantics (label roles) or languages. In some embodiments, report element metadata is also nested in section infosets (data denormalization).

Appendix F includes an example of syntax used for a rule, in accordance with some embodiments. In some embodiments, a rule infoset comprises both some metadata about the rule such as, in the example shown in Appendix F, a roll up pattern. In some embodiments, the Formula field contains the rule itself expressed in the JSONiq language. In some embodiments, the JSONiq query is executed on the fly for creating new facts or validating facts.

### DETAILED DESCRIPTION

Conventional data storage models and paradigms are inefficient and not properly equipped to scale as the volume of data and dimensionality of data continues to increase. Consequently, described herein are embodiments that allow users to quickly and efficiently deconstruct and reconstruct highly-dimensional data using a cell store paradigm.

In some embodiments, cell stores are created and utilized in order to allow for more efficient querying of large volumes of data. Cell stores provide a relational-like, tabular level of abstraction to business users while leveraging recent database technologies, such as key-value stores and document stores. This allows cell stores to scale efficiently and easily handle storage and retrieval of highly dimensional data, with a number of dimensions several orders of magnitude higher (at least 10,000 dimensions) than what conventional OLAP data cubes are able to handle. Cell stores are compatible with the XBRL standard for importing and exporting data. An example cell store repository includes 300 GB of cells filled with SEC filings data, associated with 200 GB of metadata. As shown below, retrieving data cubes from this example cell store can be performed in real time (the threshold acceptable by a human user being at most a few seconds, as shown described in more detail below and shown in Table 6).

In some embodiments, cell stores leverage state-of-the-art data storage technologies. A few non-limiting/non-exhaustive examples are as follows:
Like key-value stores and document stores, cell stores scale out with heterogeneous data. The data can be distributed across a cluster, replicated, and efficiently retrieved. They are also compatible with MapReduce-like or Spark-like parallelism paradigms.
Like the relational model, cell stores expose the table abstraction.
Like column stores, cell stores focus on projection and selection, and denormalize the data.
Like document stores, schemas are not needed upfront and can be provided at will at query time.
Like OLAP, cell stores expose the data cube abstraction to the user.
Cell stores can handle highly dimensional data and therefore cell stores allow for scaling up in the number of dimensions further than is allowable using OLAP models, because, e.g., storage works at the cell level.
Cell stores expose the data via a familiar spreadsheet-like interface to the business users, who are in complete control of their taxonomies (schemas) and rules.

In some embodiments, the cell represents the smallest possibly reportable unit of data. It has a single value, and this value is associated with dimensional coordinates that are string-value pairs. These dimensional coordinates are also called aspects, or properties, or characteristics. They uniquely identify a cell, and a consistent cell store should not contain any two cells with the exact same dimensional pairs. Nevertheless, cell stores are able to elegantly handle collisions, that is, no fatal error is generated/thrown if or when this happens.

There are no limits to the number of dimension names and their value space. As such, cell stores scale up seamlessly with the total number of dimensions. In some embodiments, there is only one required dimension called a concept, which describes what the value represents. All other dimensions are left to the user's imagination, although typically a validity period (instant or duration, i.e., when), an entity (who), a unit (of what), a transaction time, etc., are to be commonly found as well. In some embodiments, cells are stored in a single, big (and unordered) collection of cells. All the data is in this collection, and on a logical level, this collection is not partitioned or ordered in any (logical) way. In some embodiments, the unordered collection of cells is clustered and replicated to enhance the performance of the cell store.

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure pertinent aspects of the embodiments described herein.

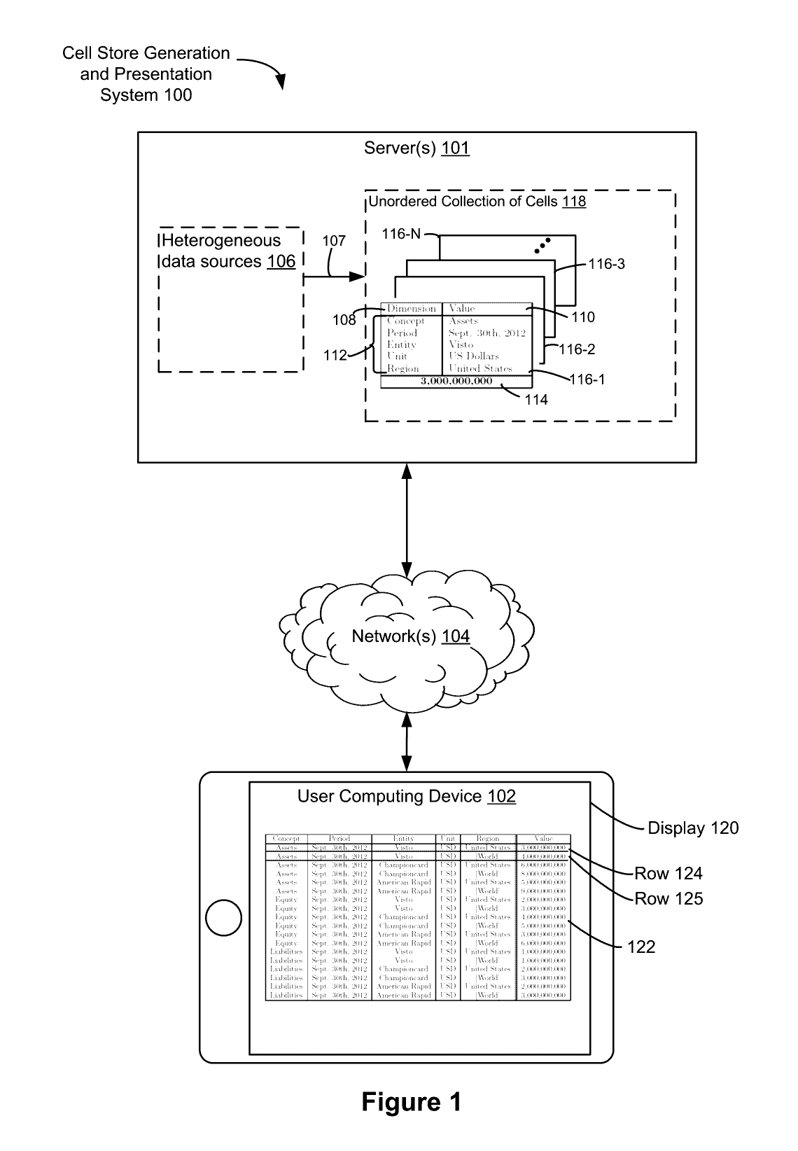

FIG. 1 is a block diagram illustrating an implementation of a cell store generation and presentation system 100, in accordance with some embodiments. As shown in FIG. 1, a cell store generation and presentation system 100 includes a user computing device 102 and also includes one or more servers 101. The user computing device 102 communicates with the one or more servers 101 over one or more networks. The one or more networks (e.g., network(s) 104) communicably connect each component of the cell store generation and presentation system 100 with other components of the cell store generation and presentation system 100. In some embodiments, the one or more networks 104 include public communication networks, private communication networks, or a combination of both public and private communication networks. For example, the one or more networks 104 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, one or more heterogeneous data sources 106 are stored on the one or more servers 101 or are available to the one or more servers 101 (e.g., through the networks 104). For example, in some embodiments, the heterogeneous data sources 106 are each stored at a location that is remotely located from the one or more servers 101.

In some embodiments, the one or more servers 101 identify a data value 114 in a first data source (e.g., a node within an XBRL value that corresponds to the data value 114) among the heterogeneous data sources 106. In some embodiments, the data value 114 is called a fact or a measure. Facts or measures correspond to the smallest reportable unit of data (e.g., one exemplary data value is a measure of a company's total assets, such as 3,000,000,000 as pictured as data value 114 in cell 116-1, FIG. 1). In some embodiments, data values are identified as being contained within nodes of an Extensible Business Reporting Language (XBRL) file, as described in more detail below. For example, one exemplary node of an XBRL file that contains a data value is the following: <ifrs-gp:OtherOperatingExpenses contextRef=“J2004” decimals=“0” unitRef=“EUR”>870000000</ifrs-gp:OtherOperatingExpenses>. In this exemplary node, the data value is 870000000 and characteristics associated with the data value are identified by locating a different node that is associated with the contextRef of J2004 as well as a different node that is associated with the unitRef of EUR. In some embodiments, the data source is a single XBRL file from which numerous data values are extracted. In some embodiments, the heterogeneous data sources 106 include a group of related XBRL files such as United States Security and Exchange Commission (SEC) filings from a single company or from related companies. In some embodiments, the heterogeneous data sources 106 include unrelated XBRL files from several reporting authorities from several countries that may use different taxonomies or taxonomy design approaches. In some embodiments, the heterogeneous data sources 106 include XBRL files, iXBRL files, and also include document stores such as MONGODB or MarkLogic, relational databases such as MySQL, graph databases such as neo4j, and the like.

In some embodiments, the one or more servers 101 extract (shown as extracting operation 107, FIG. 1), from one or more heterogeneous data sources 106, one or more characteristics 112 associated with the data value 114. In some embodiments, the extracted one or more characteristics include a number of distinct dimensions 108 and values for each of the distinct dimensions (e.g., values 110). In some embodiments or circumstances, these values are referred to as names or dimension names, in order to distinguish them from data values (e.g., a particular fact may have one data value and the fact is also associated with characteristics that include a number of dimension/value pairs). The combination of each dimension 108 and each corresponding value 110 (the combination is referred to as a characteristic) are, in some embodiments, used to distinctly identify the data value 114 as compared to other data values in each cell 116 within an unordered collection of cells 118 (e.g., the dimensions 108 (or a subset thereof, such as key characteristics/dimensions) and associated values 110 uniquely identify the data value 114 of cell 116-1). In some embodiments or circumstances, the unordered collection of cells 118 is referred to as a cell store 118. As shown in FIG. 1, exemplary dimensions include a concept dimension (associated with the value “Assets”), a period dimension (associated with the value “Sept. 30th, 2012”), an entity dimension (associated with the value “Visto”), a unit dimension (associated with the value “US Dollars”), and a region dimension (associated with the value “United States”). There are no limits to the number of dimensions 108 and associated values 110 that can be used to uniquely identify the value data 114. The dimensions 108, values 110, and data values 114 are described in further detail in Appendices A-C.

In some embodiments, the one or more servers 101 create cells 116 by extracting data from the heterogeneous data sources 106 (as explained above). In some embodiments, the created cell is represented as a JSON object. An example JSON object representing a cell is shown below (on left), as is the same cell in a tabular format (on right):

TABLE 1
JSON and Tabular Representations of a Cell

{
“Aspects ” : {
“Concept” : “us-gaap:Assets”,
“Period” : “2012-09-30”,
“Entity” : “cik:0123456789”,
“Unit” : “USD”,
“Region” : “country:United States”
}
“Value” : 3000000000
}

| Dimension | Value |
|---|---|
| Concept | Assets |
| Period | Sep. 30th, 2012 |
| Entity | Visto |
| Unit | US Dollars |
| Region | United States |

3,000,000,000

In some embodiments, a first dimension is mapped (e.g., grouped) with a second dimension such that the first and second dimensions cover the same range of values. For example, the values of “equity” and “capital” for the concept dimension are grouped together. In this way, inconsistently-named (also referred to as redundantly-named) dimensions are flagged when the cells (or the data contained therein) are presented to a user (e.g., so that the user can take action to correct the inconsistent naming). Cells are described in further detail in Appendices A-C.

In some embodiments, the one or more servers 101 store the created cells 116 in an unordered collection of cells 118 (also referred to as a cell store 118). The collection of cells is unordered, because the cells 116 contained therein have no direct one-to-one logical relation to one another. For example, the unordered collection of cells 118 can include a first created cell 116-1, a second created cell 116-2, a third created cell 116-3, through created cell 116-N. In some embodiments, the cells (e.g., 116-1, 116-2, etc.) located inside the unordered collection of cells 118 have a concept dimension in common. In this way, consistent with these embodiments, the servers 101 include one or more unordered collections of cells 118, such that each unordered collection of cells contains the cells (e.g. 116-1, 116-2, etc.) with the common concept dimension.

In some embodiments, the unordered collection of cells is referred to as a cell store and a cell store is a data cube with at least 10,000 dimensions.

In some embodiments, the one or more servers 101 receive a query via the network(s) 104. In some embodiments, the query is specified as a hypercube query. Hypercube queries allow users to flexibly model cells using any number of specified dimensions. In this way, users are able to quickly and seamlessly model cells using a first query specifying a first set of dimensions and can subsequently model those same cells (or a subset or superset thereof) using a second query that specifies a different set of dimensions. In some embodiments, the set of dimensions used in the hypercube query also includes a set of associated values as described above.

Once a cell store is constructed (as discussed above), point queries may be utilized to locate cells within an unordered collection of cells. Point queries leverage the index capabilities of the underlying storage layer. If the unordered collection of cells is small and contains many concepts, a single hash index on the concept dimension will be enough. For bigger collections, other techniques allow scaling up, such as:
compound keys: a single index on several dimensions (e.g., a single index on each of concept, period and entity dimensions); and
separate hash keys: use single indices separately, and compute their intersection.

In some embodiments, a hypercube is a dimensional range (as opposed to dimensional coordinates). It is made of a set of dimensions, and each dimension is associated with a range, which is a set of values. The range can be either an explicit enumeration (for example, for strings), or an interval (like the integers be-tween 10 and 20), or also more complex multi-dimensional ranges (consider Geographic Information Systems (GIS)).

In some embodiments, A cell belongs to a hypercube if: (i) it has exactly the same dimensions and (ii) for each dimension, the value belongs to the domain of that dimension as specified in the hypercube. Hypercubes may (and will typically) have missing cells or even be sparse.

Table 2, below, illustrates an example hypercube query and two cells that belong to the hypercube:

TABLE 2
Example Hypercube Query (left) and two Member Cells (right)

| Dimension | Value |
|---|---|
| Concept | Assets, Equity, Liabilities |
| Period | Sep. 30th, 2012, Dec. 31st, 2012 |
| Entity | Visto, Championcard, American Rapid |
| Unit | US Dollars |

| Dimension | Value |
|---|---|
| Concept | Equity |
| Period | Dec. 31st, 2012 |
| Entity | Championcard |
| Unit | US Dollars |

5,000,000,000

| Dimension | Value |
|---|---|
| Concept | Liabilities |
| Period | Dec. 31st, 2012 |
| Entity | American Rapid |
| Unit | US Dollars |

3,000,000,000

Like point queries, hypercube queries also leverage indices. Range indices, in addition to, or as an alternative to hash indices, are also user in some embodiments, in particular in the case of numeric or date dimension values. Domain-specific indices like GIS may also be used in some embodiments.

In some embodiments, the one or more servers 101 locate cells (e.g., 116-1, 116-2, etc.) within the unordered collection of cells 118 in response to a received hypercube query (e.g., those cells having dimensions and/or associated values that match the hypercube query). The one or more servers 101 then send (e.g., via the network(s) 104) data corresponding to the cells (e.g., data value 114, dimensions 108, and/or values 110) to the user computing device 102. In some embodiments, the user computing device 102 includes a display 120 and the display 120 is configured to render a tabular representation 122 corresponding to data corresponding to the cells. In this way, the cell store generation and presentation system 100 is able to provide a familiar representation of data to business users (e.g., a relational-like presentation of the data, even though the data is not stored using a relational data storage model). In some embodiments, hypercube queries are submitted by simply interacting with a displayed tabular representation (e.g., in response to addition or removal of dimensions or values from the tabular representation 122, FIG. 1, the user computing device 102 submits an updated hypercube query via network(s) 104 to the one or more servers 101). In some embodiments, the tabular representation is displayed in a business intelligence tool (as discussed above in the “Summary” section at A12) that displays cells and allows for the submission of hypercube queries.

Table 3, below, illustrates an example hypercube query and two member cells:

TABLE 3
Example Hypercube Query (left) and Member Cells (right)

| Dimension | Value |
|---|---|
| Concept | Assets, Equity, Liabilities |
| Period | Sep. 30th, 2012 |
| Entity | Visto, Championcard, American Rapid |
| Unit | US Dollars |
| Region | United States, [World] |

| Dimension | Value |
|---|---|
| Concept | Assets |
| Period | Sep. 30th, 2012 |
| Entity | Vistco |
| Unit | US Dollars |
| Region | United States |

3,000,000,000

| Dimension | Value |
|---|---|
| Concept | Assets |
| Period | Sep. 30th, 2012 |
| Entity | Visto |
| Unit | US Dollars |
| Region | [World] |

4,000,000,000

As shown in Table 3, some hypercube queries specify default dimension values (e.g., the illustrated hypercube defines a default value of “[World]” for the “Region” dimension). If a hypercube specifies a default value for a given dimension, then the condition that a cell must have that dimension to be included in the hypercube is relaxed. In particular, a cell will also be included if it does not have a “Region” dimension. When this happens, an additional dimensional pair is added to the cell on the fly, using the default value as value. This implies that in the end, the set of cells that gets returned always has exactly the same dimensions specified in the hypercube query.

In some embodiments, cells that are members of a particular hypercube query are presented in a consolidated way, such as in a tabular format (e.g., a spreadsheet or another graphical format familiar to business users such as those available through TABLEAU). An example tabular format (including cells that are members of the hypercube query shown in Table 3 is presented in Table 4 below:

TABLE 4
User Interface Shown in response to Hypercube Query of Table 3

| Concept | Period | Entity | Unit | Region | Value |
|---|---|---|---|---|---|
| Assets | Sep. 30th, 2012 | Visto | USD | United States | 3,000,000,000 |
| Assets | Sep. 30th, 2012 | Visto | USD | [World] | 4,000,000,000 |
| Assets | Sep. 30th, 2012 | Championcard | USD | United States | 6,000,000,000 |
| Assets | Sep. 30th, 2012 | Championcard | USD | [World] | 8,000,000,000 |
| Assets | Sep. 30th, 2012 | American Rapid | USD | United States | 5,000,000,000 |
| Assets | Sep. 30th, 2012 | American Rapid | USD | [World] | 9,000,000,000 |
| Equity | Sep. 30th, 2012 | Visto | USD | United States | 2,000,000,000 |
| Equity | Sep. 30th, 2012 | Visto | USD | [World] | 3,000,000,000 |
| Equity | Sep. 30th, 2012 | Championcard | USD | United States | 4,000,000,000 |
| Equity | Sep. 30th, 2012 | Championcard | USD | [World] | 5,000,000,000 |
| Equity | Sep. 30th, 2012 | American Rapid | USD | United States | 3,000,000,000 |
| Equity | Sep. 30th, 2012 | American Rapid | USD | [World] | 6,000,000,000 |
| Liabilities | Sep. 30th, 2012 | Visto | USD | United States | 1,000,000,000 |
| Liabilities | Sep. 30th, 2012 | Visto | USD | [World] | 1,000,000,000 |
| Liabilities | Sep. 30th, 2012 | Championcard | USD | United States | 2,000,000,000 |
| Liabilities | Sep. 30th, 2012 | Championcard | USD | [World] | 3,000,000,000 |
| Liabilities | Sep. 30th, 2012 | American Rapid | USD | United States | 2,000,000,000 |
| Liabilities | Sep. 30th, 2012 | American Rapid | USD | [World] | 3,000,000,000 |

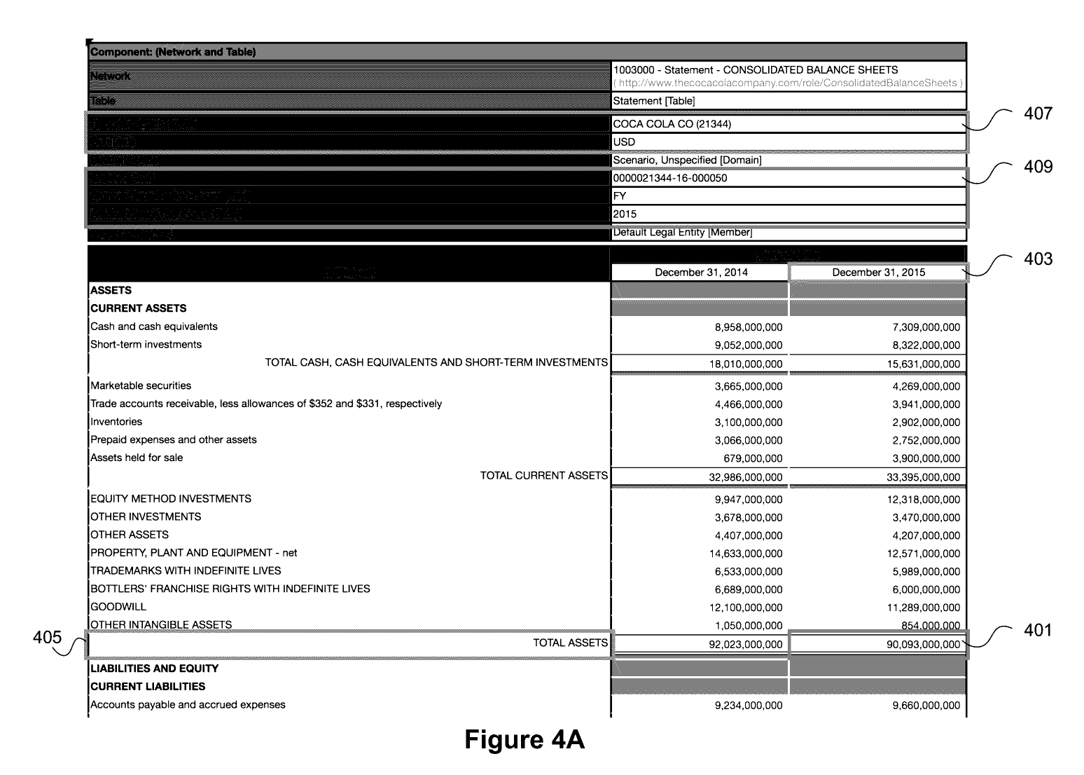

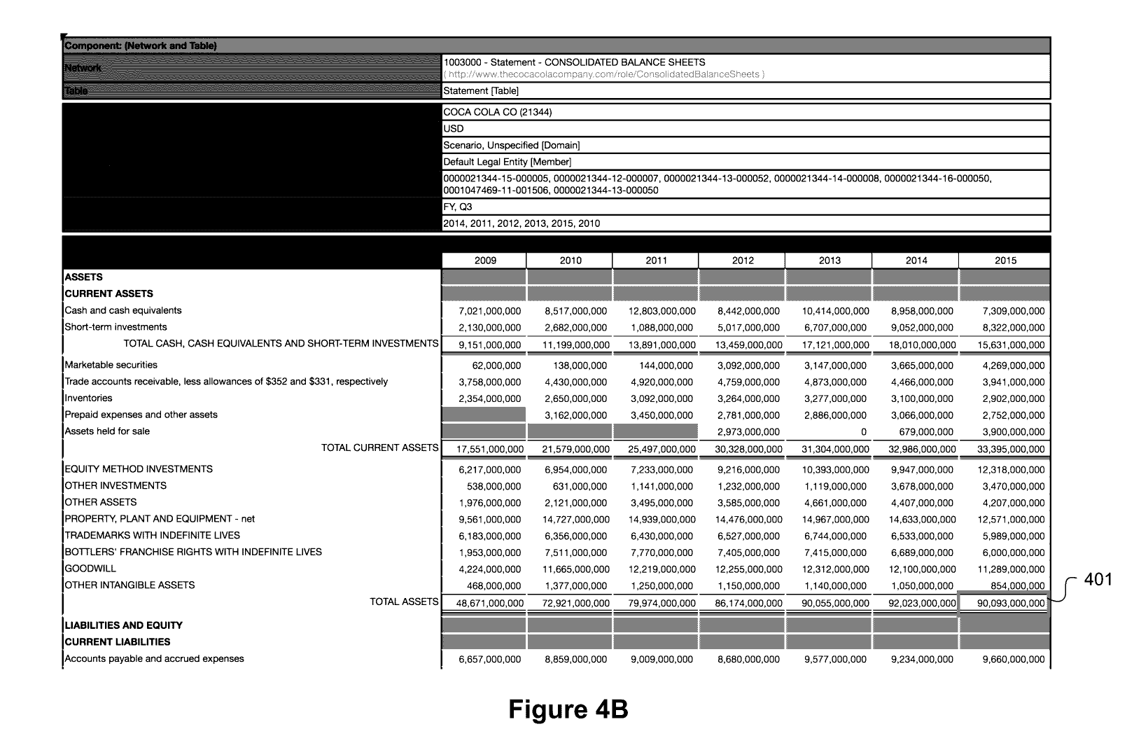

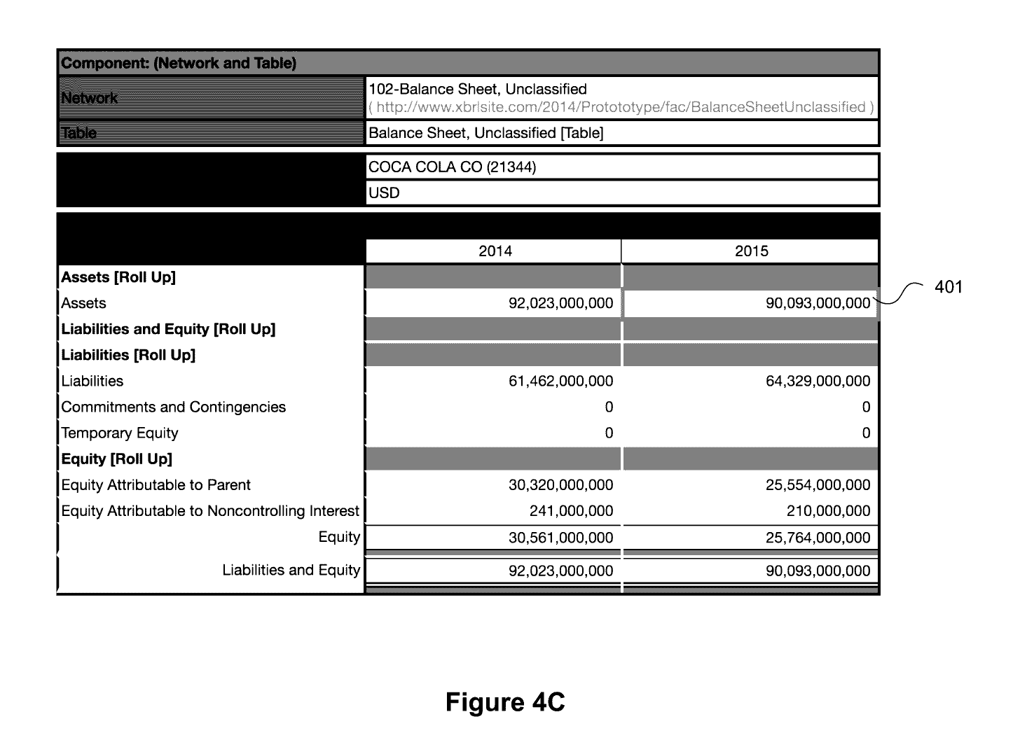

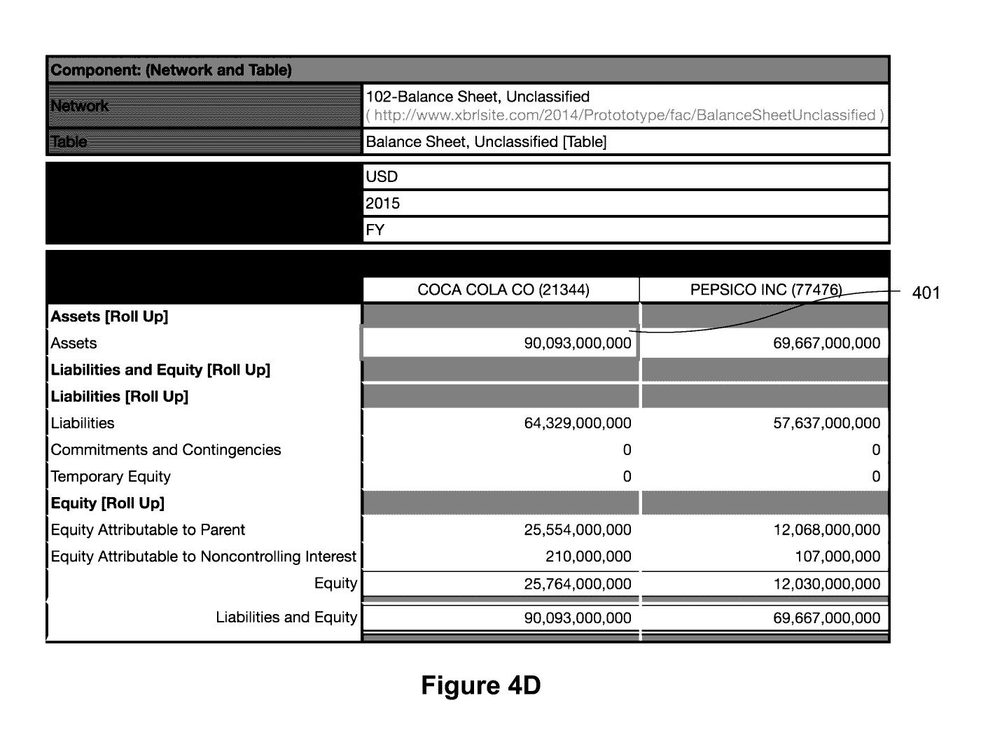

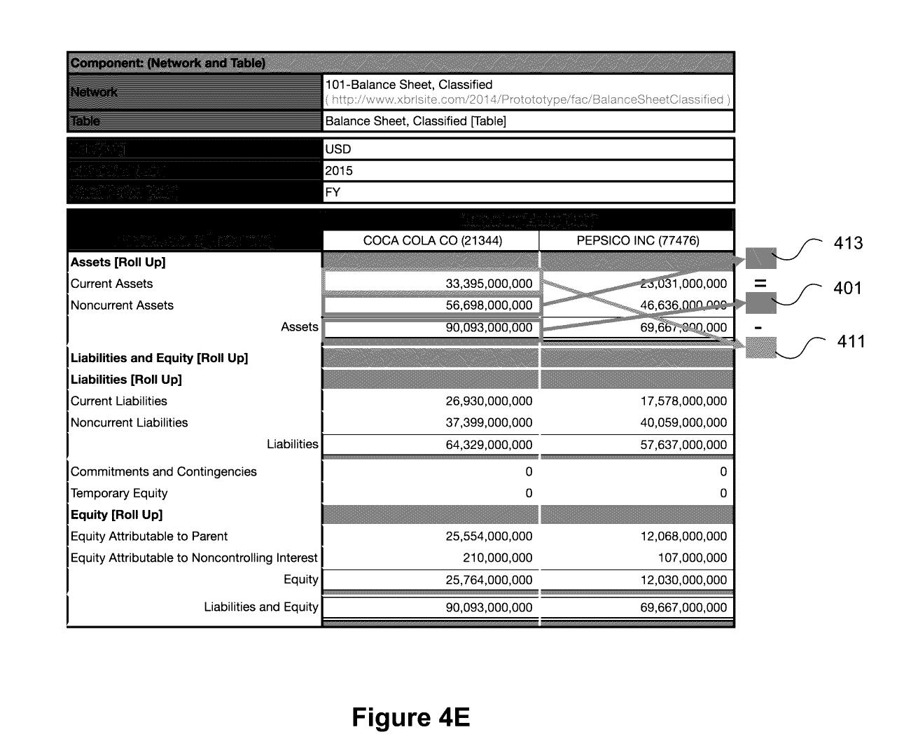

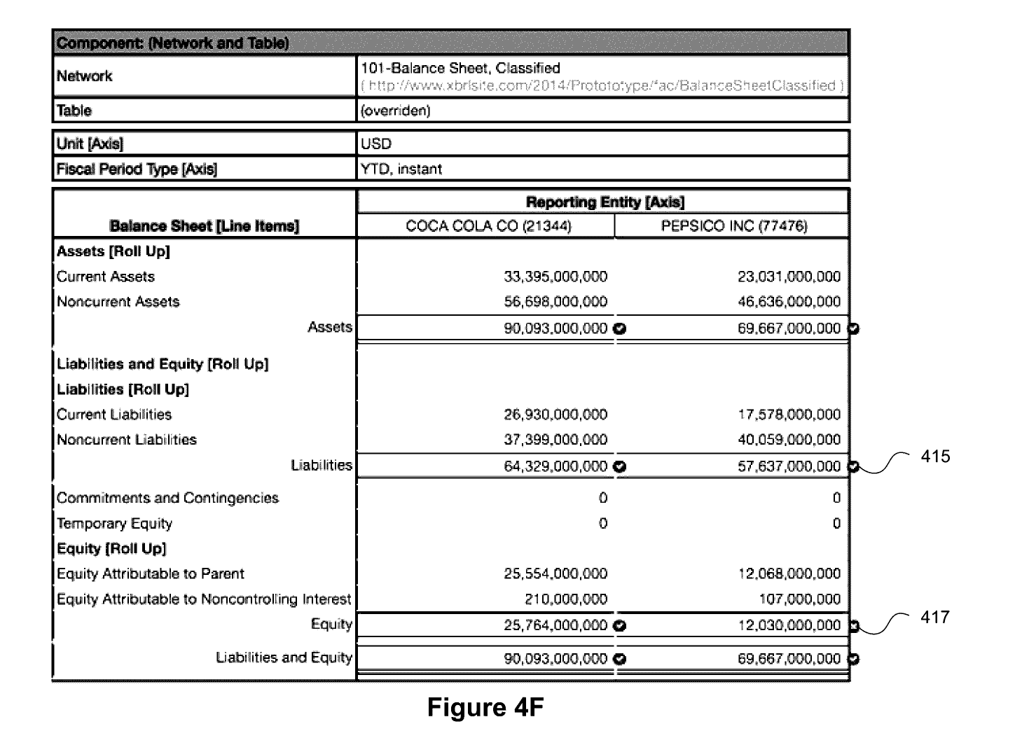

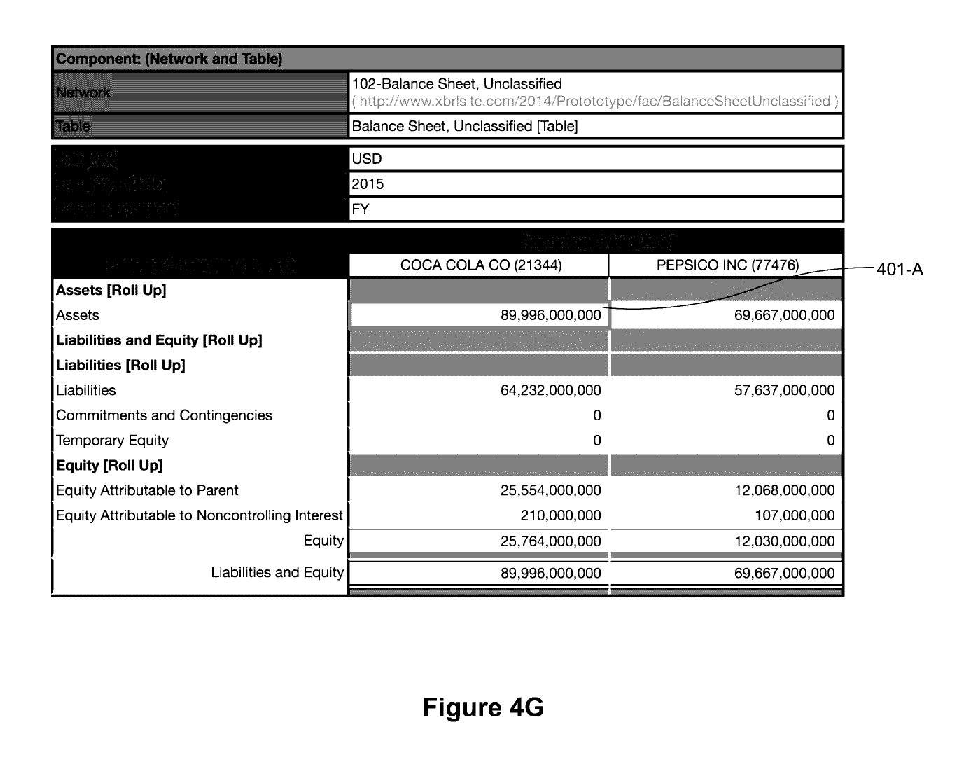

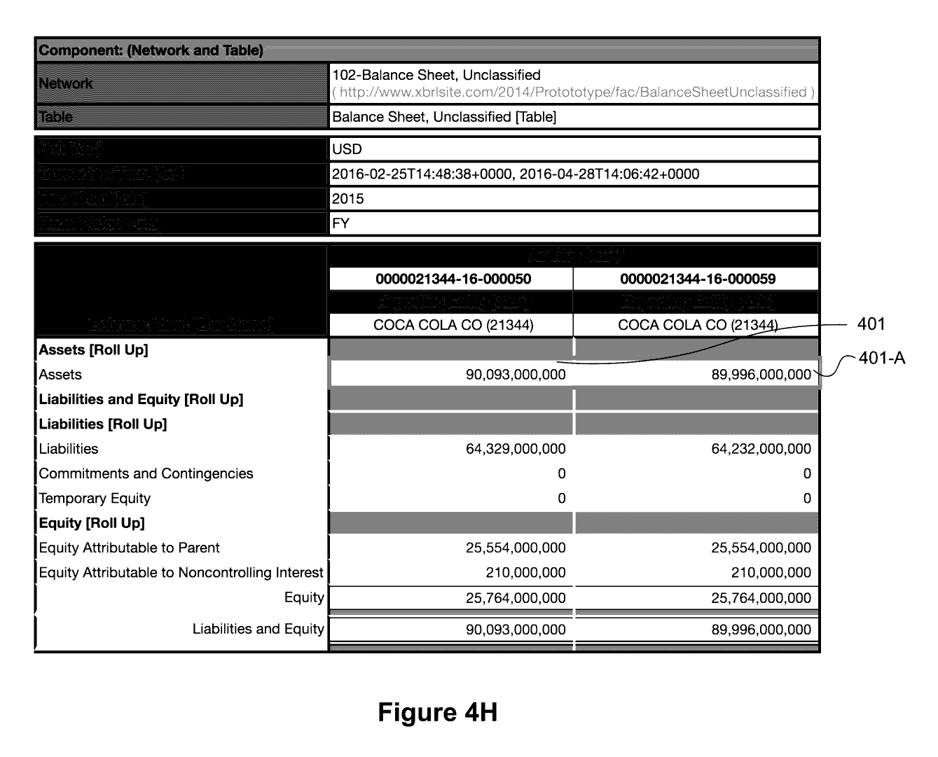

In some embodiments, the one or more servers 101 validate a particular fact (e.g., data value 114) associated with a specific cell (e.g., cell 116-1). The one or more servers 101 validate the particular fact by comparing the particular fact to other related facts (e.g., related facts are identified because they have one or more dimensions and associated values in common with the particular fact, as discussed above in the “Summary” section) in the tabular representation. In this way, inconsistencies or obvious calculation and/or data entry errors are easily flagged and resolved automatically (e.g., without any human intervention from a user). Validating facts is also discussed below in reference to FIG. 4F.

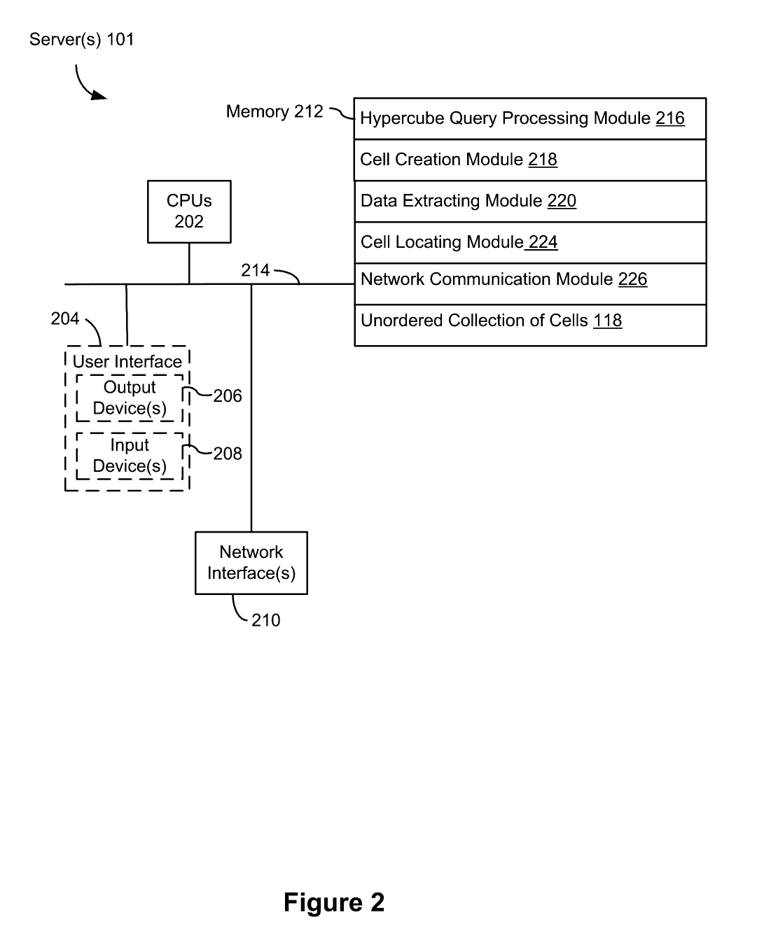

FIG. 2 is a block diagram illustrating an exemplary server (e.g., one of the servers 101, FIG. 1), in accordance with some embodiments. Server 101 typically includes one or more processing units (sometimes called CPUs or processors) 202 for executing modules, programs, and/or instructions stored in memory 212 (and thereby performing processing operations), one or more network (or other communications) interfaces 210, memory 212 (sometimes called controller memory), and one or more communication buses 214 for interconnecting these components. The one or more communication buses 214 optionally include circuitry (sometimes called a chipset) that interconnects and controls communications between system components.

As also shown in FIG. 2, the server 101 optionally includes a user interface 204, including output device(s) 206 and input device(s) 208. In some embodiments, the input devices include a keyboard, mouse, or track pad. Alternatively, or in addition, in some embodiments, the user interface 204 includes a display device that includes a touch-sensitive surface, in which case the display device is a touch-sensitive display. In servers and/or user computing devices that have a touch-sensitive display, a physical keyboard is optional (e.g., a soft keyboard may be displayed when keyboard entry is needed). The output devices (e.g., output device(s) 206) also optionally include speakers or an audio output connection connected to speakers, earphones, or headphones. Furthermore, some servers 101 use a microphone and voice recognition device to supplement or replace the keyboard. Optionally, the server 101 includes an audio input device (e.g., a microphone) to capture audio (e.g., speech from a user). Optionally, the server 101 includes a location-detection device, such as a GPS (global positioning satellite) or other geo-location receiver, and/or location-detection software for determining the location of the server 101.

Memory 212 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 212 optionally includes one or more storage devices remotely located from the CPU(s) 202. Memory 212, or alternatively the non-volatile memory device(s) within memory 212, comprises a non-transitory computer readable storage medium.

In some embodiments, memory 212, or the non-transitory computer-readable storage medium of memory 212 stores the following programs, modules, and data structures, or a subset or superset thereof:
hypercube query processing module 216 for receiving queries that specify a set of one or more required characteristics (e.g., dimensions 108 and associated values 110, FIG. 1) and, in response to the received query, providing data corresponding to cells that match the specified set of one or more required characteristics;
cell creation module 218 for receiving data that has been extracted from heterogeneous data sources and creating cells corresponding to the extracted data;
data extracting module 220 for extracting one or more characteristics from a data source and providing the extracted data to the cell creation module 218 (e.g., by parsing an XBRL file to identify data values and characteristics associated therewith);
cell locating module 224 for mining through an unordered collection of cells (e.g., unordered collection of cells 118, FIG. 1) and locating a cell;
network communication module 226 for sending and receiving, via the network(s) 104 (FIG. 1), data between the servers 101 and the user computing device 102 (e.g., data used to render tabular representations of data); and
unordered collection of cells 118 for storing cells.

Although described above as components of an exemplary server 101, in some other embodiments, the modules and components described above are implemented at a user computing device 102. Also, consistent with these other embodiments, the user interface 204 is presented on the display 120 of the user computing device 102 as shown in FIG. 1.

Each of the above identified elements may be stored in one or more of the previously-mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 212 may store a subset of the modules and data structures identified above. Furthermore, memory 212 may store additional modules and data structures not described above. In some embodiments, the programs, modules, and data structures stored in memory 212, or the non-transitory computer-readable storage medium of memory 212, provide instructions for implementing some of the methods described below. In some embodiments, some or all of these modules may be implemented with specialized hardware circuits that subsume part or all of the module functionality.

### Example Implementations

In some embodiments, cell stores are implemented on top of a document store (such as MONGODB/NoLAP). In some embodiments, implementations on top of the document store utilize only two collections: facts and components. In some embodiments, each fact is a JSON object (as depicted in table 1 above). In some embodiments, several indexes on the fields used most (concept, entity) make sure hypercube queries are efficient. Hypercube queries can directly be translated to MONGODB queries, and hence almost completely pushed to the server backend. In some embodiments, components include all the metadata is stored for all of the cells. In some embodiments, each component contains a hierarchy of concepts, a couple of hypercubes, a spreadsheet definition, business rules, concept metadata such as labels in various languages, and documentation. Given a component, data cubes or spreadsheet views can be built.

In some embodiments, another collection (concepts) is used in order to optimize querying for concepts, including full text search, and finding out which components they appear in.

In some embodiments, Hypercube queries or spreadsheet queries are made via a REST API, implemented in JSONiq and executed with an underlying Zorba engine. In some embodiments, computation is performed using cloud computing resources (such as though available via Amazon's EC2 machines), and data is also hosted using cloud computing resources (such as compose.io). Table 5 below illustrates execution times for one implementation of a cell store repository on top of a document store.

TABLE 5
Execution times for Cell Store Implementation
on Top of MongoDB

| | Number | |
|---|---|---|
| Type of query | of cells | Time |
| Point query | 1 | 130 ms |
| Row query, across one dimension (Assets of DOW | 31 | 150 ms |
| 30 companies for the fiscal year 2014) | | |
| Slice query, across two dimensions (Assets of | 191 | 340 ms |
| DOW 30 companies for several reported fiscal | | |
| years) | | |
| Query of all cells in a component, including | 90 | 650 ms |
| mapping, rule execution and validation | | |
| Building a spreadsheet out of a component, | 403 | 1200 ms |
| including mapping, rule execution and validation | | |

(a) Specific one-time measurments

| | Average | Minimum | Maximum |
|---|---|---|---|
| Response time to static hypercube | 195.3 | 121.1 | 450.1 |
| queries (over entire filing), in | | | |
| milliseconds | | | |
| Number of facts retrieved in static | 20.6 | 1 | 177 |
| hypercube queries | | | |
| Number of dimensions of static | 7.7 | 7 | 13 |
| hypercubes | | | |
| Response time to static hypercube | 197 | 120.7 | 542.4 |
| queries with validation, in milliseconds | | | |
| Number of valdiated facts (roll-up | 2.1 | 0 | 54 |
| and roll-forward rules) | | | |

(b) Query times and statistics of 160 real-world static hypercubes
contained in a fiscal report (American Express, Q2, 201 [symbol] ). Static
hypercubes typically overlap and share facts even though they have
different dimensions, because of the default dimension machinery. [symbol]
indicates data missing or illegible when filed

In some embodiments, cell stores may also be implemented on top of a column store (e.g., CASSANDRA). In one example, dimensions are set up as non-primary-key columns, using a UUID primary key instead. Secondary indices on the dimensional columns ensure efficient hypercube retrieval. In order to take advantage of the flexibility of CASSANDRA with respect to columns, the concept dimension could be handled separately, with all cells corresponding to the same business object (that is, all dimensions but concept have the same values) on the same row.

In some embodiments, cell stores may also be implemented on top of a key-value store. For example, the data in a cell store could be stored in a key-value store, possibly in an optimized format for retrieval and for saving space.

In some embodiments, cell stores may be implemented on top of a graph database. For example, a cell store could be stored in a graph database, by splitting each cell into several triples: the subject is the cell, it has one predicate for each dimension leading to the dimension value (as an object), and a predicate leading to the cell value.

Other implementations will also be apparent to and appreciated by those of ordinary skill in the art.

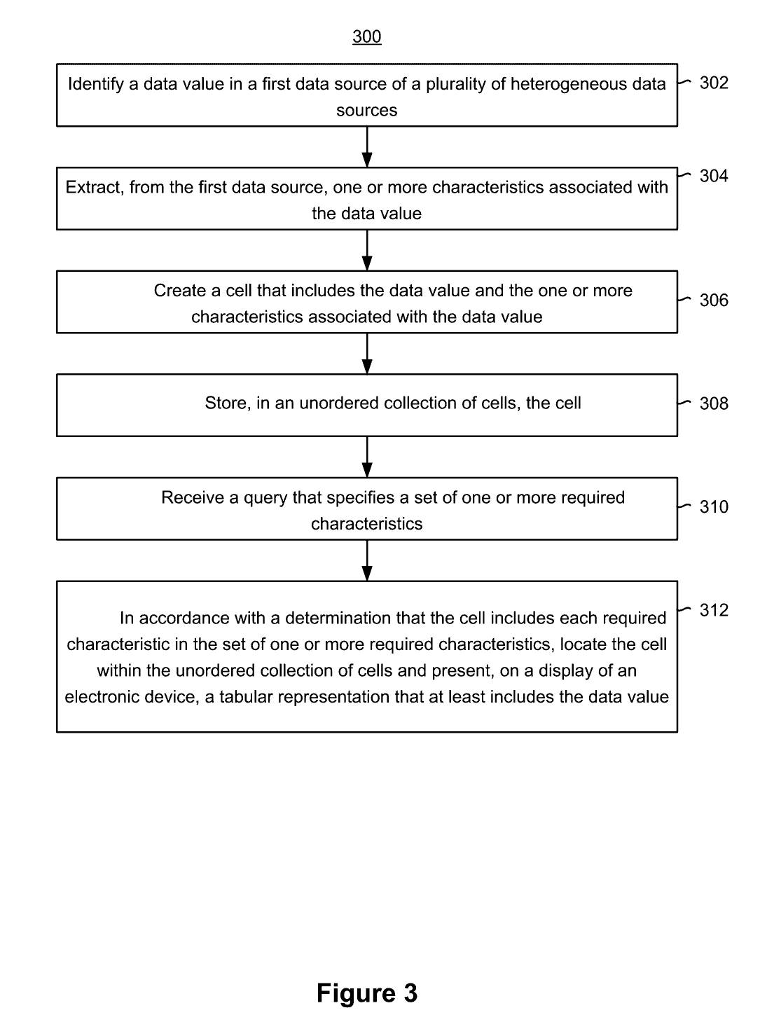

FIG. 3 illustrates a flowchart representation of a method of storing and interacting with data from heterogeneous data sources, in accordance with some embodiments. With reference to the cell store generation and presentation system 100 pictured in FIG. 1, in some embodiments, a method 300 is performed by an electronic device (e.g., server 101 or user computing device 102) or one or more components of the electronic device. In some embodiments, the method 300 is governed by instructions that are stored in a non-transitory computer-readable storage medium (e.g., memory 212, FIG. 2) and that are executed by one or more processors of a device, such as the one or more processing units (CPUs) of the electronic device (e.g., CPUs 202 of server 101, FIG. 2). In some embodiments, some of the operations of method 300 are performed at a client device (e.g., user computing device 102) that is operatively coupled with the server 101 and other operations of method 300 are performed at the server 101. For ease of explanation, the following describes method 300 as performed by the server 101. With reference to FIG. 2, in some embodiments, the operations of method 300 are performed, at least in part, by a hypercube query processing module (e.g., hypercube query processing module 216, FIG. 2), a cell creation module (e.g., cell creation module 218, FIG. 2), a data extracting module (e.g., data extracting module 220, FIG. 2), a cell locating module (e.g., cell locating module 224, FIG. 2), and a network communication module (e.g., network communication module 226, FIG. 2). Some operations in method 300 are, optionally, combined and/or the order of some operations is, optionally, changed.

In some embodiments, the method 300 and the cell store paradigm as a whole is able to work with highly dimensional data. In one experiment, a full scan of a megadimensional cell store (including all EDGAR filings, such as 10-K, 10-Q, and the like submitted by US companies to the SEC in an XBRL format) was conducted. The experiment revealed that there are approximately 19,000 report elements defined in US GAAP, but there are 200 times as many report elements created by filers (also referred to as extensions). The experiment also revealed that all facts submitted could only be housed in a hypercube capable of scaling to approximately 45,000 dimensions. Conventional data storage models cannot scale to this level of dimensionality—the cell store paradigm described herein scales to this number of dimensions and beyond.

In some embodiments, a server (e.g., server 101, FIG. 1, or a component thereof such as data extracting module 220, FIG. 2) identifies (302) a data value in a first data source of a plurality of heterogeneous data sources. In some embodiments, the data value is a first data value of a plurality of data values in the first data source (e.g., a first node within an XBRL file) and the identifying operation 302 is performed with respect to each additional data value of the plurality of data values in the first data source (e.g., each node in the XBRL file of the preceding example). In some embodiments, the identifying operation 302 is also performed for each data source (in addition to the first data source) of the plurality of heterogeneous data sources (e.g., for a MongoDB, a MySQL DB, a PostgreSQL DB, and other database management systems used to store data).

In some embodiments, the server (e.g., server 101, FIG. 1, or a component thereof, such as data extracting module 220, FIG. 2) extracts (304), from the data source, one or more characteristics associated with the data value. In some embodiments, the extracted one or more characteristics include pairs of dimensions and values associated therewith (e.g., one exemplary characteristic is a dimension of “Concept” and a value of “Assets,” as shown in cell 116-1 of FIG. 1). In some embodiments, characteristics are referred to as dimensional coordinates, such that each pair of dimension and its associated value reflects a particular dimensional coordinate position. In some embodiments, only the concept dimension is required for each cell 116 (FIG. 1), and other dimensions are optional.

In some embodiments, the server (e.g., server 101, FIG. 1, or a component thereof such as cell locating module 224) creates (306) a cell that includes the data value and the extracted one or more characteristics associated with the data value. For example, the server extracts the data value and characteristics associated therewith from nodes in an XBRL file and creates cell 116-1 with the extracted information.

In some embodiments, the server (e.g., server 101, FIG. 1) stores (308), in an unordered collection of cells (e.g., unordered collection of cells 118, FIG. 2), the created cell. In some embodiments, the unordered collection of cells includes a logically unordered and un-partitioned pool of cells. Storing cells is further explained in Appendix A, for example, at pages 3 and 9.

In some embodiments, the extracting operation 304, the creating operation 306, and/or the storing operation 308 are performed with respect to each data value within the plurality of data values in the first data source (e.g., for each node within the XBRL file as discussed above in reference to operation 302).

In some embodiments, the server (e.g., server 101, FIG. 1) receives (310), a query that specifies a set of one or more required characteristics. In some embodiments, the query is a hypercube query specified by a user (e.g., a user of the user computing device 102). In some embodiments, the query specifies a set of characteristics (e.g., dimensions 108 and associated values 110, FIG. 1) that are associated with a cell (e.g., cell 116-1 or 116-2, FIG. 1) within the unordered collection of cells 118. For example, the received query includes the concept dimension with a value of assets and the entity dimension with a value of Visto. In some embodiments, the hypercube query processing module 216 and/or the cell locating module 224 mine(s) through the unordered collection of cells 118, in order to identify cells that exactly match the dimensions and associated values specified by the received query.

In some embodiments, the query that is received includes greater than 10 required characteristics (or dimensions) and the server is able to process and respond to the query specifying more than 10 dimensions (e.g., 16 or more dimensions) in sub-second processing times (i.e., processing times that are substantially the same as processing times for queries specifying less than 10 dimensions). In contrast, conventional OLAP data warehouses become slower with hypercube queries containing more than 10 dimensions.

In some embodiments, in accordance with a determination that the created cell includes each required characteristic in the set of one or more required characteristics, and (also or alternatively) in accordance with a determination that the set of one or more required characteristics includes all of the key characteristics associated with the created cell (e.g., a determination conducted by the hypercube query processing module 216), the server (e.g., server 101, FIG. 1 or a component thereof such as cell locating module 224) locates (312) the created cell within the unordered collection of cells and presents, on a display of an electronic device, a tabular representation that at least includes the data value (e.g., tabular representation 122 is presented on a display 120 of the user computing device 102).

In some embodiments, the tabular representation 122 includes a row of data corresponding to the created cell (e.g., row 124). For example, the created cell is cell 116-1 and, therefore, the row 124 includes data value 114 (3,000,000,000) and characteristics associated with data value 114 (e.g., as shown in FIG. 1, the row 124 includes all the characteristics 112 of cell 116-1 (i.e., all of the dimensions 108 and associated values 110)). In some embodiments, presenting the tabular representation includes sending (e.g., by the server 101) the tabular representation to a remote device, such as the user computing device 102 (e.g., via the network(s) 104, FIG. 1). In some embodiments, dimensions (e.g., dimensions 108, FIG. 1) and associated values (e.g., values 110, FIG. 1) of the created cell 116, as well as a data value (e.g., data value 114, FIG. 1) if applicable, are associated with human-readable labels in one or more languages. In this way, the created cell 116 (FIG. 1) is displayed to a user in a language of his or her choice.

From a business viewpoint, presenting data in a tabular representation is very useful because these representations are readily digestible by end business users without IT knowledge/intervention. In some embodiments, spreadsheets that incorporate pivot tables are used to convey information that is responsive to hypercube queries (an example is shown in Table 6 below).

TABLE 6
A spreadsheet view over a hypercube, for viewing and editing data without IT
knowledge. As shown, concepts are put on rows and the other dimensions on filters or
on columns. The spreadsheet front end can support drag-and-drop, allowing the user to
interactively rearrange rows, columns and filters. Default values are handled with L-
shape cells.
Unit USD
Period Sep. 30th, 2012

| | Entity | | | | | |
|---|---|---|---|---|---|---|
| | Visto | | Championcard | | American Rapid | |
| | Region | | Region | | Region | |
| Line items | United States | | United States | | United States | |
| Assets | 3,000,000,000 | 4,000,000,000 | 6,000,000,000 | 8,000,000,000 | 5,000,000,000 | 9,000,000,000 |
| Equity | 2,000,000,000 | 3,000,000,000 | 4,000,000,000 | 5,000,000,000 | 3,000,000,000 | 6,000,000,000 |
| Liabilities | 1,000,000,000 | 1,000,000,000 | 2,000,000,000 | 3,000,000,000 | 2,000,000,000 | 3,000,000,000 |

In this way, business users can utilize spreadsheets and spreadsheet editing software to drag and drop dimensions across the different categories to fine tune their view over the data. Because cell stores can use all the experience accumulated over several decades on pivot tables from the spreadsheet industry, they offer a powerful and business friendly interface, shielding users from the underlying dimensional complexity. Additionally, the use of a spreadsheet front-end provides the following advantages (among others): 1) the size of the data available to business users (via unordered collections of cells) is orders of magnitude bigger than a spreadsheet file; 2) the data lies on a server and is shared across a department or a company; and the latest database technologies are leveraged under the hood to scale up and out, without the need to go through the IT department for each change in the business taxonomy.

Additional examples of tabular representations are shown and discussed in more detail in reference to FIGS. 4A-4H.

### Example Use Cases

In this section, details are provided to show how a fact, initially reported inside an XBRL instance using its XML syntax, can flow through storage (the cell store's proprietary JSON infoset), through the cell store and all the way to the user on a spreadsheet rendering to illustrate how fact storage scales up seamlessly and efficiently. Details provided in this section also explain how concept maps, rules and validation can be performed with this fact, in accordance with some embodiments. This section also includes details explaining how report elements such as dimensions and members are stored, to illustrate how dimensional storage scales up as well, in accordance with some embodiments.

On the XML syntactic level, an XBRL fact looks like so (taken from a 10-Q filing for Coca-Cola for Q1 2016):

<us-gaap:Assets contextRef=″FI2015Q4″ decimals=″−6″
id=″Fact-D7D9ED51B3872B3D867083BA5EA47DE1″
unitRef=″usd″>90093000000</us-gaap:Assets>

This fact has the value 90,093,000,000 and describes Assets rounded to the million (−6 decimals). This value has a context with the id FI2015Q4. Looking up in the same instance, this context looks like:

```
<xbrli:context id=″FI2015Q4″>
  <xbrli:entity>
    <xbrli:identifier scheme=″http://www.sec.gov/CIK″>
      0000021344 </xbrli:identifier>
  </xbrli:entity>
  <xbrli:period>
    <xbrli:instant>2015-12-31</xbrli:instant>
  </xbrli:period>
</xbrli:context>
```

One can hence see that the above fact is about Coca Cola (CIK 21344), and is valid on Dec. 31, 2015 (that's Coca Cola's FY number for 2015). The XBRL fact also has a unit with an id of usd. Looking up in the same instance, this unit looks like:

<xbrli:unit id=″usd″>
<xbrli:measure>iso4217:USD</xbrli:measure>
</xbrli:unit>

In this example, the XBRL fact expresses assets in US dollars (currency code USD according to ISO 4217).

The XBRL syntax is compact in the sense that facts share contexts, which saves space. However, from a processing perspective, this is very inefficient, because context, units and facts must be joined on the fly. Hence, the above fact is imported to 28 msec's proprietary infoset and converted to a JSON object, stored in the facts pool. The object consolidates all aspects of the fact (i.e., the XBRL syntax is denormalized) in a unified way that corresponds to XBRL's dimensional aspect model:

```
{
    ″KeyAspects″ : [
      ″xbrl:Period″,
      ″xbrl:Entity″,
      ″xbrl:Concept″,
      ″xbrl:Unit″ ],
    ″Aspects″ : {
      ″xbrl:Period″ : ″2015-12-31″,
      ″xbrl:Entity″ : ″http://www.sec.gov/CIK 0000021344″,
      ″xbrl:Concept″ : ″us-gaap:Assets″,
      ″xbrl:Unit″ : ″iso4217:USD″
    },
    ″Value″ : 90093000000,
    ″Decimals″ : −6
  }
```

The object is also enriched with additional aspects that make processing easier: the archive ID (EDGAR accession number), the fiscal period (FY) and year (2015).

```
{
    ″KeyAspects″ : [
      ″xbrl:Period″,
      ″xbrl:Entity″,
      ″xbrl:Concept″,
      ″xbrl:Unit″ ],
    ″Aspects″ : {
      ″xbrl28:ArchiveFiscalPeriodFocus″ :
      ″FY″, ″xbrl28:Archive″ :
      ″0000021344-16-000050″,
      ″xbrl28:ArchiveFiscalYearFocus″ : 2015,
      ″xbrl:Period″ : ″2015-12-31″,
      ″xbrl:Entity″ : ″http://www.sec.gov/CIK 0000021344″,
      ″xbrl:Concept″ : ″us-gaap:Assets″,
      ″xbrl:Unit″ : ″iso4217:USD″
    },
    ″Value″ : 90093000000,
    ″Decimals″ : −6
  }
```

The proprietary JSON format of each fact is stored in a database (e.g., a document store), and secondary indices are built on the aspects (for example, a compound index on (xbrl28:Archive, xbrl:Concept)) so that facts can be retrieved in real time given their aspects.

In some embodiments, facts are retrieved and then presented in a tabular representation for use by end users. An example user interface including a tabular representation (e.g., a spreadsheet that displays data retrieved from a cell store) with the above example fact is shown below in FIG. 4A.

As shown in FIG. 4A, the fact used as an example above is circled and labeled as fact 401. It lies at the intersection of the period 403 (Period: Dec. 31, 2015) and concept 405 (Concept: Total Assets). Furthermore, (Reporting Entity: Coca Cola) and (Unit: USD) appear in the slicers, also circled and labeled as 407. The three additional (virtual) aspects (archive, fiscal year focus and fiscal period focus) are also circled and labeled as 409.

In some embodiments, to display the spreadsheet, the cell store issues a query to the database layer that asks for all the relevant facts (including the above example fact 401). In some embodiments, the facts are then attributed to their respective cells. In some embodiments, all of this processing is performed on the fly and on a database that includes hundreds of millions or facts or more, beyond the typical limits of a single, conventional XBRL instance.

Turning now to FIG. 4B, an example user interface that includes a hypercube query that has been performed across instances is presented. In some embodiments, because facts are stored in one big pool, they may be retrieved across instances, for example across all fiscal years reported by a particular company (e.g., all fiscal years for Coca Cola, as shown in FIG. 4B). The example fact 401 described above is labeled in FIG. 4B.

In some embodiments, different terminology is utilized by various companies to refer to similar concepts. In some embodiments, a mapping referred to as a concept map is utilized to ensure that consistent terminology is used for these similar concepts. An example of a standardized report is shown below:

```
{
  ″KeyAspects″ : [
      ″xbrl:Period″,
      ″xbrl:Entity″,
      ″xbrl:Concept″, ″xbrl:Unit″ ],
    ″Aspects″ : {
      ″xbrl:Period″ : ″2015-12-31″,
      ″xbrl:Entity″ : ″htip://www.sec.gov/CIK
      0000021344″, ″xbrl:Concept″ : ″fac:Assets″,
      ″xbrl:Unit″ : ″iso4217:USD″
    },
    ″Value″ : 90093000000,
    ″Decimals″ : −6,
    ″AuditTrails″ : [ {
      ″Type″ : ″xbrl28:concept-maps″,
      ″Label″ : ″Concept map″,
      ″Message″ : ″fac:Assets -> us-gaap:Assets″,
      ″Data″ : {
        ″OriginalConcept″ : ″us-gaap:Assets″,
        ″OutputConcept″ : ″fac:Assets″
    }
  }]
}
```

As shown above, a mapping is established between “fac:Assets” and “us-gaap:Assets” and thus the concept for reporting assets is named fac:Assets, and is mapped to us-gaap:Assets. This creates a new fact that has this new name. In some embodiments, audit trails are included that allow tracing back the provenance of the value (as shown in the example above). FIGS. 4C-4D illustrate example user interfaces with tabular representations showing fact 401. In some embodiments, the concept mapping discussed above is used in order to ensure that data (such as overall assets) are displayed correctly with the tabular representation.

In some embodiments, additional facts are dynamically computed in order to provide additional information to business users and to help validate the accuracy of reported information.

Another fact that some companies report on their financial reports is fac:CurrentAssets, obtained with a concept map just like fac:Assets. What some of these companies do not report, however, doesn't report, is noncurrent assets. Since fac:NoncurrentAssets cannot be mapped, a formula is used instead: fac:NoncurrentAssets=fac:Assets−fac:CurrentAssets to create a new fact on the fly and an audit trail is included with the new fact to explain how a value for noncurrent assets was computed:

```
{
    ″KeyAspects″ : [
      ″xbrl:Period″,
      ″xbrl:Entity″,
      ″xbrl:Concept″,
      ″xbrl:Unit″ ],
    ″Aspects″ : {
      ″xbrl:Period″ : ″2015-12-31″,
      ″xbrl:Entity″ : ″http://www.sec.gov/CIK 0000021344″,
      ″xbrl:Concept″ : ″fac:NoncurrentAssets″,
      ″xbrl:Unit″ : ″iso4217:USD″
    },
    ″Value″ : 56698000000,
    ″Decimals″ : −6,
    ″AuditTrails″ : [ {
      ″Type″ : ″xbrl28:formula″,
      ″Label″ : ″Computation of NoncurrentAssets″,
      ″Message″ : ″NoncurrentAssets[56,698,000,000 USD] =
      fac:Assets[90,093,000,000 USD]
      -
  fac:CurrentAssets[33,395,000,000 USD]″,
      ″Data″ : {
        ″OutputConcept″ : ″fac:NoncurrentAssets″
    }
    }
    ]
}
```

In some embodiments, facts that are based on explicitly reported information and computed facts based on that information are all presented in the tabular representations. For example, as shown in FIG. 4E, current assets 411, noncurrent assets 413, and total assets 401 are all shown.

In some embodiments, consistency checks are also performed to validate that the data presented in a particular tabular representation is accurate. One example consistency check is to validate that fac:Assets=fac:CurrentAssets+fac:NoncurrentAssets.

In some embodiments, these consistency are implemented by creating a new fact called fac:AssetsValidation that has a boolean value (true if the above formula is correct, false otherwise). In some embodiments, an audit trail included with the fac:AssetsValidation details the formula used and the values considered.

```
{
    ″KeyAspects″ : [
      ″xbrl:Period″,
      ″xbrl:Entity″,
      ″xbrl:Concept″,
      ″xbrl:Unit″ ],
    ″Aspects″ : {
      ″xbrl:Period″ : ″2015-12-26″,
      ″xbrl:Entity″ : ″http://www.sec.gov/CIK
      0000077476″, ″xbrl:Concept″ :
      ″fac:AssetsValidation″,
      ″xbrl:Unit″ : ″iso4217:USD″
    },
    ″Value″ : true,
    ″AuditTrails″ : [ {
      ″Id″ : ″RollUp3″,
      ″Type″ : ″xbrl28:validation″,
      ″Label″ : ″RollUp validating $fac:Assets (source: calculation)″,
      ″Message″ : ″fac:Assets[90,093,000,000 USD] =
      ( fac:CurrentAssets[33,395,000,000 USD])
  + ( fac:NoncurrentAssets[56,698,000,000 USD])″,
      ″Data″ : {
        ″OutputConcept″ : ″fac:AssetsValidation″,
        ″ValidatedConcepts″ : [ ″fac:Assets″ ],
        ″ValidatedFacts″ : [ ],
        ″ValidationPassed″ : null
    }
    }
    ]
}
```

In some embodiments, the results of these consistency checks are also shown on a user interface (e.g., with the tabular representations discussed above). An example is shown on FIG. 4F, in which a visual indicator is provided to show whether a consistency check has been passed or not (e.g., passing indicator 415 and failing indicator 417, FIG. 4F).

In some embodiments, a new version of a cell may be added to the cell store dynamically, for example when new information that affects a cell's data value appears in one of the data sources, or when a user interactively modifies the value of a cell (e.g., a new version of a cell is created in response to a user modifying the value of a cell or in response to a change in the data that was originally used to create the cell). In some embodiments, a cell store versioning mechanism ensures that all cells are considered (including new versions of cells) and unchanged hypercube queries still consider these new versions of cells. For example, as shown by comparing FIG. 4D to FIG. 4G, a data value for Coca Cola's assets changed from an originally reported value of 90,093,000,000 (e.g., reported in a first SEC filing and shown in FIG. 4D) to a modified value of 89,996,000,000 (e.g., reported in a later SEC filing, in which a new data value for assets was reported, as shown for 401-A in FIG. 4G). FIG. 4H shows how it is also possible to display old (e.g., 401) and new versions (e.g., 401-A) of an entire hierarchy of concepts for a particular cell side-by-side (e.g., as shown in FIG. 4H, both of the asset values discussed above are displayed in a side-by-side manner for easy analysis and comparison by users). In this way, cell stores are able to flexibly adapt to changing data values and ensure that all relevant and current information is available and presented to users (as noted above, existing hypercube queries need not be modified to ensure retrieval of more up-to-date information, as the cell store ensures that all new versions of cells are considered).

In addition to consistency checks, some embodiments also utilize other rules to help ensure data accuracy. One example of these other rules is an imputation rule. In some embodiments, an imputation rule computes a value for a missing cell (i.e., dimensional coordinates against which no value was reported). When generated, this cell comes along with an audit trail that indicates how the value was computed, and from which other cells.

In this way, cell stores scale up seamlessly in terms of the number of facts, by letting facts freely flow around, by computing new facts and/or validating facts on the fly, and by augmenting facts them with audit trails so that computations are traceable back to original values.

In some embodiments, report elements are also stored as JSON infoset objects in a cell store. In some embodiments, these report elements are stored in a single pool of report elements, ignoring boundaries of taxonomies or instances. An example is provided below:

```
{
    Kind: ″Concept″,
    Name: ″us-gaap:Assets″,
    DataType: ″xbrli:MonetaryItemType″,
    PeriodType : ″instant″,
    Balance: ″debit″
}
```

Two additional examples taken from the US GAAP taxonomy are also shown below (stored in the cell store JSON infoset):

```
{
    Kind: ″Dimension″,
    Name: ″us-gaap:MajorTypesOfDebtAndEquitySecuritiesAxis″
    DimensionType : ″xbrl28:explicit″
}
{
    Kind: ″Member″,
    Name: ″us-gaap:EquitySecuritiesMember″
    Dimensions:
    [ ″us-gaap:MajorTypesOfDebtAndEquitySecuritiesAxis″ ]
}
```

One example of a fact (stored in JSON infoset) is shown below that uses the example dimension and member discussed above:

```
{
  ″KeyAspects″ : [
    ″us-gaap:MajorTypesOfDebtAndEquitySecuritiesAxis″,
    ″xbrl:Period″,
    ″xbrl:Entity″,
    ″xbrl:Concept″,
    ″xbrl:Unit″
  ],
  ″Aspects″ : {
    ″us-gaap:MajorTypesOfDebtAndEquitySecuritiesAxis″ :
            ″us-gaap:EquitySecuritiesMember″,
    ″xbrl:Period″ : ″2015-12-31″,
    ″xbrl:Entity″ : ″http://www.sec.gov/CIK 0000021344″,
    ″xbrl:Concept″ :
    ″us-gaap:AvailableForSaleSecuritiesAmortizedCost″,
    ″xbrl:Unit″ : ″iso4217:USD″,
  },
  ″Value″ : 3573000000,
  ″Decimals″ : −6
}
```

In some embodiments, dimensions and members are quickly and easily created on the fly, thus allowing the cell store paradigm to scale up efficiently. In some embodiments, members and facts are all stored as flat lists, and creating a new dimension in the cell store (such as the examples provided above) is no more complex than a few inserts: (1) Adding this new dimension to the pool of report elements; (2) Adding a few members intended to be used as dimension values to the pool of report elements; and (3) Adding facts that use this dimension (1) and associate it with members (2) to the pool of facts.

In some embodiments, tables are then created on the fly with any dimensions desired (typically up to 10-20 in typical scenarios), including any newly created dimensions.

In contrast, conventional ROLAP models require modifying a schema and regenerating an entire table, in order to add a single dimension. Hence, any new incoming financial reporting filing, potentially with new dimensions, may be imported into the cell store with only inserts and no changes of schema. With flat lists of report elements, both storage and performance grow linearly with the number of dimensions.

### Converting Relational Data to a Cell Store Model

In some embodiments, data that is stored using a conventional storage structure (such as a relational model) may be converted to individual cells in a cell store. For example, a relational table may be converted to a cell store (or a cell gas) and its corresponding hypercube as follows: each attribute in the primary key is converted to a dimension. A cell is then created for each row and for each value on that row that is not a primary key. This cell is associated with the dimensions values corresponding to the primary keys on the same row, plus the concept dimension associated with the name of the attribute corresponding to the column.

In this way, an entire relational database with multiple tables, or even several relational databases, may be converted into a single cell store, with no walls between the original tables. Likewise, relational views can be built dynamically on top of a cell store.

It will be understood that, although the terms “first,” “second,” etc. may be used herein to describe various elements, these elements should not be limited by these terms. These terms are only used to distinguish one element from another. For example, a first data value could be termed a second data value, and, similarly, a second data value could be termed a first data value, without changing the meaning of the description, so long as all occurrences of the “first data value” are renamed consistently and all occurrences of the “second data value” are renamed consistently. The first data value and the second data value are both data values, but they are not the same data value.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the phrase “at least one of A, B and C” is to be construed to require one or more of the listed items, and this phase reads on a single instance of A alone, a single instance of B alone, or a single instance of C alone, while also encompassing combinations of the listed items such “one or more of A and one or more of B without any of C,” and the like.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for querying data, comprising:
identifying a data value in a first data source of a plurality of heterogeneous data sources;
extracting, from the first data source, one or more characteristics associated with the data value;
creating a cell that includes the data value and the one or more characteristics associated with the data value;
storing, in an unordered collection of cells, the cell;
receiving a query that specifies a set of one or more required characteristics; and
in accordance with a determination that the cell includes each required characteristic in the set of one or more required characteristics, locating the cell within the unordered collection of cells and, presenting, on a display of an electronic device, a tabular representation that at least includes the data value.

2. The method of claim 1, wherein the query further specifies a set of optional characteristics and, in accordance with a determination that the cell does not include the set of optional characteristics, temporarily assigning a default value to the cell for each optional characteristic in the set of optional characteristics.

3. The method of claim 1, wherein presenting the tabular representation comprises validating the data value by comparing the data value to other data values that are determined to be related to the data value.

4. The method of claim 3, wherein validating the data value includes visually flagging the data value within the tabular representation in accordance with a determination that the data value is not valid.

5. The method of claim 1, further comprising:
in accordance with a determination that no cells in the unordered collection of cells include each required characteristic in the set of one or more required characteristics, estimating, based on historical data values that include at least a subset of the one or more required characteristics, a new data value that includes an audit trail that describes how the new data value was estimated.

6. The method of claim 1, further comprising:
partitioning the one or more characteristics associated with the cell into key characteristics and non-key characteristics; and
before locating or presenting the created cell, determining whether the set of one or more required characteristics includes all the key characteristics associated with the created cell; and
wherein the determination that the created cell includes each required characteristic in the set of one or more required characteristics includes determining that the set of one or more required characteristics includes all the key characteristics associated with the created cell.

7. The method of claim 1, wherein the data value is a first data value of a plurality of data values in the first data source and further wherein the extracting, the creating, and the storing are performed with respect to each data value within the plurality of data values in the first data source.

8. The method of claim 1, wherein presenting the tabular representation that at least includes the data value comprises determining whether a first characteristic of the one or more characteristics is redundantly-named and in accordance with a determination that the first characteristic is redundantly-named, presenting a notification to a user that the first characteristic is redundantly-named.

9. The method of claim 1, wherein the one or more characteristics include a concept dimension and a concept name, a period dimension and a period name, and an entity dimension and an entity name.

10. The method of claim 1, wherein the unordered collection of cells is associated with an index that is based on at least one of the one or more characteristics associated with the data value.

11. The method of claim 10, wherein the locating is performed using the index.

12. The method of claim 1, where the cell is represented using JavaScript Object Notation.

13. The method of claim 1, wherein the tabular representation, in addition to the data value, also includes a representation of the one or more required characteristics.

14. A non-transitory computer-readable storage medium storing executable instructions that, when executed by one or more processors of an electronic device, cause the electronic device to perform operations comprising:
identifying a data value in a first data source of a plurality of heterogeneous data sources;
extracting, from the first data source, one or more characteristics associated with the data value;
creating a cell that includes the data value and the one or more characteristics associated with the data value;
storing, in an unordered collection of cells, the cell;
receiving a query that specifies a set of one or more required characteristics; and
in accordance with a determination that the cell includes each required characteristic in the set of one or more required characteristics, locating the cell within the unordered collection of cells and, presenting, on a display of an electronic device, a tabular representation that at least includes the data value.

15. An electronic device, comprising:
one or more processors; and
memory storing one or more programs which, when executed by the one or more processors, cause the electronic device to perform operations comprising.
identifying a data value in a first data source of a plurality of heterogeneous data sources;
extracting, from the first data source, one or more characteristics associated with the data value;
creating a cell that includes the data value and the one or more characteristics associated with the data value;
storing, in an unordered collection of cells, the cell;
receiving a query that specifies a set of one or more required characteristics; and
in accordance with a determination that the cell includes each required characteristic in the set of one or more required characteristics, locating the cell within the unordered collection of cells and, presenting, on a display of an electronic device, a tabular representation that at least includes the data value.
